(19) United States
(12) Patent Application Publication
(10) Pub. No.: US 2015/0057894 A1
(43) Pub. Date: Feb. 26, 2015

(54) VEHICLE CONTROL SYSTEM AND VIRTUAL ELECTRONIC CONTROL UNIT DEVELOPMENT METHOD

(71) Applicant: Hyundai Motor Company, Seoul (KR)

(72) Inventors: Woochul JUNG, Seoul (KR); Young Woo CHOI, Incheon-si (KR)

(73) Assignee: Hyundai Motor Company, Seoul (KR)

(21) Appl. No.: 14/101,117

(22) Filed: Dec. 9, 2013

(30) Foreign Application Priority Data
Aug. 26, 2013 (KR) 10-2013-0101159

(51) Int. Cl. B60R 1/02; B60W 50/00

(52) U.S. Cl. CPC B60R 1/02; B60W 50/00; B60W 50/0098; B60W 2050/0004
USPC 701/49; 701/36

(57) ABSTRACT

A vehicle control system includes a sensing unit configured to sense a vehicle state and generate a vehicle state signal; an application program interface (API) conversion unit configured to generate an API corresponding to the vehicle state signal; and an actuator controlled by a virtual electronic control unit (ECU). In this case, the virtual ECU is a virtual ECU program programmed using the API and installed in a dummy ECU block of a terminal.

### CROSS-REFERENCE TO RELATED APPLICATION

This application claims priority to and the benefit of Korean Patent Application No. 10-2013-0101159 filed in the Korean Intellectual Property Office on Aug. 26, 2013, the entire contents of which are incorporated herein by reference.

### BACKGROUND

(a) Field of the Invention

The present disclosure relates to a vehicle control system for controlling a vehicle and a virtual electronic control unit (ECU) development method.

(b) Description of the Related Art

In order to drive various kinds of convenient apparatus, there is a need to develop an electronic control unit (ECU) driving an actuator depending on logic in response to values of various sensors in a vehicle. It is believed that there are no means to replace numerous micro controllers for controlling a vehicle based on a today's technological paradigm. However, a new type of vehicle control technology may be implemented based on a conceptual shift and technology application at the time when vehicle IT technology is developed and various applications driven by web control are present.

A micro controller for determining whether a vehicle is operated by reading a vehicle sensor value performs a simple operation (logic) in real time based on a real time operating system (RTOS) to perform essential functions, such as a control of an engine, a control of a brake, and a control of convenient apparatuses, in a vehicle.

FIG. 1 is a diagram illustrating a vehicle control system according to related art using an ECU 30.

The vehicle control system includes a sensing unit 10, an input interface unit 20, an ECU 30, and an actuator 40.

The sensing unit 10 includes a plurality of sensors and senses a state of a vehicle using the sensors.

The input interface unit 20 receives vehicle state information from the sensing unit.

The ECU 30 controls the actuator 40 depending on logic in response to the vehicle state information which is received from the input interface unit 20. The ECU 30 includes an input port 31, a CPU 32, an output port 33, and a memory 34.

The actuator 40 drives various vehicle apparatus (for example, a side mirror, a wiper, and the like) depending on a control of the ECU 30. The actuator 40 includes a driving circuit which drives the vehicle apparatus corresponding thereto.

Meanwhile, an individual ECU of a vehicle may not be able to have additional functions or improved performance until the ECU is physically changed. Considering that the lifespan period of a vehicle is about 10 years, a consumer may not add individual ECU functions or improve performance of the individual ECU, beyond functions of the initial state of the vehicle when first purchased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a programmable ECU development method using existing sensor information and a vehicle control system for controlling a vehicle using a virtual ECU.

An exemplary embodiment of the present invention provides a vehicle control system that includes a sensing unit configured to sense a vehicle state and generate a vehicle state signal; an application program interface (API) conversion unit configured to generate an API corresponding to the vehicle state signal; and an actuator controlled by a virtual electronic control unit (ECU). In this case, the virtual ECU is a virtual ECU program programmed using the API and installed in a dummy ECU block of a terminal.

The API conversion unit may include a data gateway configured to connect a plurality of vehicle networks and receive the vehicle state signal; a filter configured to filter the vehicle state signal received by the data gateway; and an API module configured to generate the API corresponding to the filtered vehicle state signal.

The vehicle control system may further include a converter configured to convert the vehicle state signal into a digital signal and output the converted digital signal to the data gateway when the vehicle state signal is an analog signal; and a digital input buffer configured to buffer the vehicle state signal and output the buffered vehicle state signal to the data gateway when the vehicle state signal is a digital signal.

The terminal may include the plurality of dummy ECU blocks.

The terminal may be any one of an audio video navigation (AVN) apparatus and a mobile terminal.

The virtual ECU may be installed in the dummy ECU block to meet a runtime environment of the terminal.

The virtual ECU may control the actuator in response to the vehicle state signal.

Another exemplary embodiment of the present invention provides a virtual ECU development method. The virtual ECU development method includes sensing, by a sensor, a vehicle state and generating a vehicle state signal; generating, by an API module, an API corresponding to the vehicle state signal; and programming a virtual ECU using the API. In this case, the virtual ECU may be installed in a terminal and control an actuator in response to the vehicle state signal.

### BRIEF DESCRIPTION OF THE DRAWINGS

FIG. 1 is a diagram illustrating a vehicle control system according to the related art.

FIG. 2 is a diagram illustrating a vehicle control system according to an exemplary embodiment of the present invention.

FIG. 3 is a diagram illustrating an example in which the vehicle control system according to the related art drives a vehicle apparatus.

FIG. 4 is a diagram illustrating an example in which the vehicle control system according to the exemplary embodiment of the present invention drives the vehicle apparatus.

FIG. 5 is a flow chart illustrating a process of developing a virtual ECU according to an exemplary embodiment of the present invention.

FIG. 6 is a flow chart illustrating a process in which the vehicle control system according to the exemplary embodiment of the present invention controls a vehicle.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

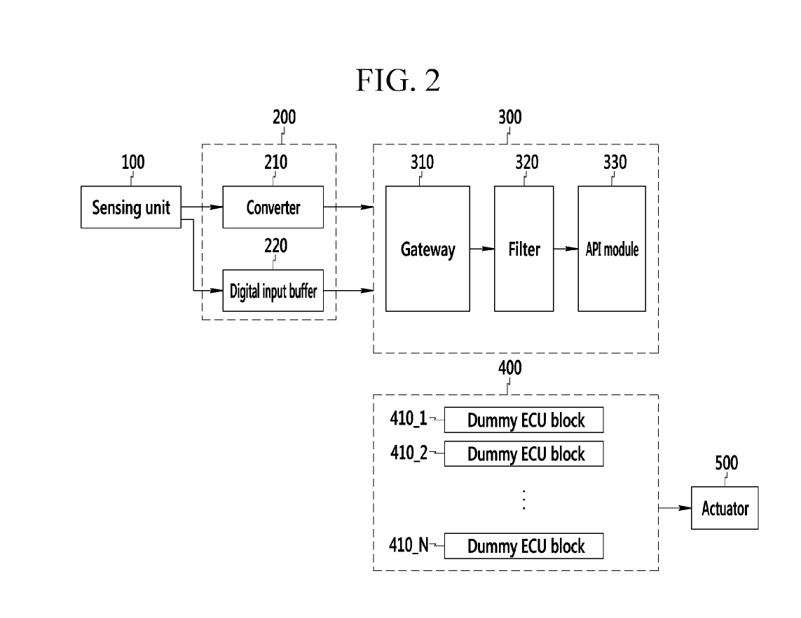

FIG. 2 is a diagram illustrating a vehicle control system 1000 according to an exemplary embodiment of the present invention.

The vehicle control system 1000 includes a sensing unit 100, an input interface unit 200, an API conversion unit 300, a vehicle terminal 400, and an actuator 500.

The sensing unit 100 includes a plurality of sensors and senses a state of a vehicle to generate vehicle state signals. Here, the vehicle state signal may be an analog signal or a digital signal depending on characteristics of the sensors.

The input interface unit 200 receives the vehicle state signal which is generated by the sensing unit 100. The input interface unit 200 may include an analog to digital converter (AD converter) 210 which converts the vehicle state signal, which is an analog signal, into a digital signal when the vehicle state signal is the analog signal and a digital input buffer 220 which buffers the vehicle state signal, which is a digital signal, when the vehicle state signal is the digital signal.

The API conversion unit 300 generates an application program interface (API) which corresponds to the vehicle state signal received from the input interface unit 200. That is, the API conversion unit 300 converts the vehicle state signal received from the input interface unit 200 into a programmable function. Here, the function defines the meaning of the received vehicle state signal and defines a range of a value of the vehicle state signal. The API conversion unit 300 may include a gateway 310, a filter 320, and an API module 330. The gateway 310 connects a plurality of vehicle networks and receives the vehicle state signal through each of the vehicle networks. More specifically, the gateway 310 receives integrated data. The filter 320 filters only a required signal among the vehicle state signals received by the gateway 310. The API module 330 converts the vehicle state signal passing through the filter 320 into the API.

The vehicle terminal 400 includes a plurality of dummy ECU blocks 410_1 to 410_N. The vehicle terminal 400 may be an audio video navigation (AVN) apparatus, a tablet PC, or a mobile terminal such as a smart terminal. A virtual ECU installed in the dummy ECU blocks 410_1 to 410_N of the vehicle terminal 400. In this configuration, the virtual ECU includes logic which is a virtual ECU program programmed using the API generated by the API conversion unit 300 and corresponds to the received vehicle state signal. The virtual ECU controls the actuator 500 in response to the vehicle state signal. The virtual ECU is installed in any one of the plurality of dummy ECU blocks 410_1 to 410_N and is installed to meet a runtime environment of the vehicle terminal 400. For example, a user may download the virtual ECU from a server and install the downloaded virtual ECU in the dummy ECU blocks 410_1 to 410_N of the vehicle terminal 400.

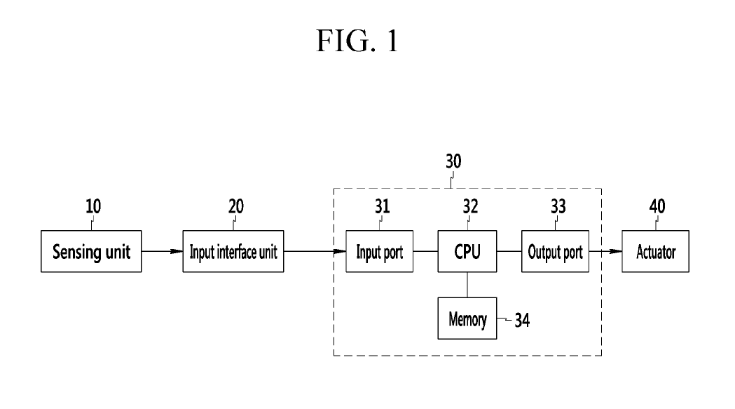

The actuator 500 is controlled by the virtual ECU which is installed in the vehicle terminal 400. Meanwhile, the actuator 500 is also controlled by the existing ECU (for example, 30 of FIG. 1) which is installed in the vehicle. That is, the actuator 500 drives various vehicle apparatus (for example, a side mirror, a wiper, and the like) depending on controls of the existing ECU (for example, 30) installed in a vehicle and the virtual ECU which are installed in the vehicle terminal 400. More specifically, the actuator 500 includes a driving circuit (for example, actuator control API) which drives the various vehicle apparatus (for example, side mirror) that correspond the actuator 500.

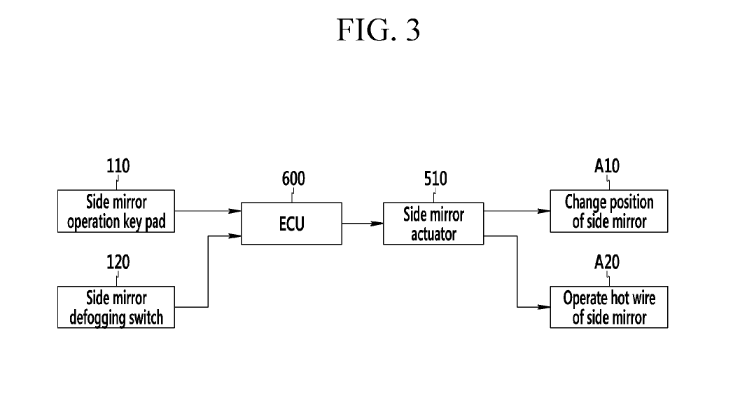

FIG. 3 is a diagram illustrating an example in which the vehicle control system according to the related art drives a specific vehicle apparatus (for example, side mirror). FIG. 3 illustrates an operation in which the ECU (or body control module (BCM) 600) controls a side mirror actuator 510 depending on values of sensors 110 and 120 associated with the side mirror, for convenience of explanation. In this configuration, an ECU 600 is an ECU which is installed in a vehicle like the ECU 30 of FIG. 1.

A side mirror operation key pad 110 or a side mirror defogging switch 120 senses an operation (for example, a pressing) by a user. Further, the side mirror operation key pad 110 or the side mirror defogging switch 120 transfers the vehicle state signal corresponding to the operation by the user to the ECU 600.

The ECU 600 controls the side mirror actuator 510 in response to the received vehicle state signal. For example, the ECU 600 may output a first control signal to the side mirror actuator 510 in response to the vehicle state signal received from the side mirror operation key pad 110. Further, the ECU 600 may output a second control signal to the side mirror actuator 510 in response to the vehicle state signal received from the side mirror defogging switch 120.

The side mirror actuator 510 controls the side mirror depending on the control of the ECU 600. For example, when the side mirror actuator 510 receives the first control signal from the ECU 600, the side mirror actuator 510 changes a position of the side mirror (A10). Further, when the side mirror actuator 510 receives the second control signal from the ECU 600, the side mirror actuator 510 operates a hot wire of the side mirror for defogging (A20).

Meanwhile, the ECU 600 may not add new functions or update functions in addition to the existing functions A10 and A20 until the ECU 600 is physically changed.

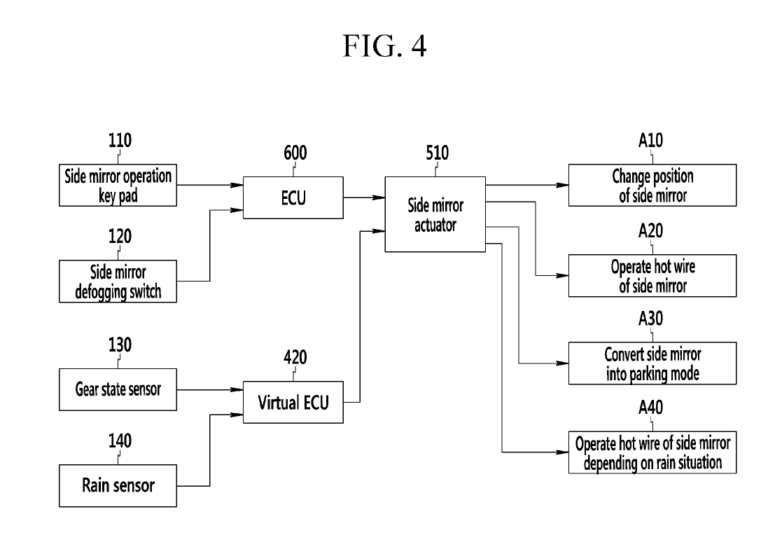

FIG. 4 is a diagram illustrating an example in which the vehicle control system according to the exemplary embodiment of the present invention drives the vehicle apparatus (for example, side mirror). As illustrated in FIG. 4, according to the exemplary embodiment of the present invention, new ECU functions A30 and A40 may be added to the existing ECU functions A10 and A20.

FIG. 4 illustrates an operation in which the ECU 600 and a virtual ECU 420 controls the side mirror actuator 510 depending on the values of the sensors 110 to 140 associated with the side mirror, for convenience of explanation. Here, the ECU 600 is an ECU which is installed in a vehicle like the ECU 30 of FIG. 1 and the virtual ECU 420 is a virtual ECU program which is installed in the dummy ECU block (for example, 410_1). Further, the sensors 110 to 140 are included in the sensing unit 100 and the side mirror actuator 510 is included in the actuator 500.

A gear state sensor 130 senses a gear state to transfer the vehicle state signal corresponding to the gear state to the virtual ECU 420. Further, a rain sensor 140 senses a rain drop to transfer the vehicle state signal corresponding to a rain drop situation to the virtual ECU 420.

The virtual ECU 420 controls the side mirror actuator 510 in response to the received vehicle state signal. For example, the virtual ECU 420 may output a third control signal to the side mirror actuator 510 in response to the vehicle state signal received from the gear state sensor 130. Further, the virtual ECU 420 may output a fourth control signal to the side mirror actuator 510 in response to the vehicle state signal received from the rain sensor 140.

The side mirror actuator 510 controls the side mirror depending on the control of the virtual ECU 420. For example, when the side mirror actuator 510 receives the third control signal from the virtual ECU 420, the side mirror actuator 510 controls the side mirror to meet an operation mode (for example, a parking mode or a driving mode) corresponding to the gear state (A30). Further, when the side mirror actuator 510 receives the fourth control signal from the virtual ECU 420, the side mirror actuator 510 operates the hot wire of the side mirror depending on a rain situation (A40).

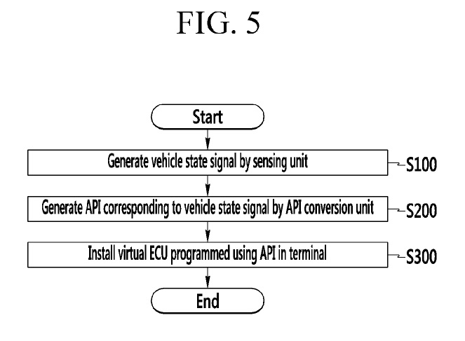

FIG. 5 is a flow chart illustrating a process of developing the virtual ECU according to an exemplary embodiment of the present invention.

The sensing unit 100 senses a vehicle state to generate the vehicle state signal (S100). The vehicle state signal generated by the sensing unit 100 is transferred to the API conversion unit 300 via the input interface unit 200.

The API conversion unit 300 generates the API corresponding to the vehicle state signal passing through the gateway 310 and the filter 320 (S200). Here, the vehicle state signal transferred to the API module 330 may be a vehicle state signal which is not used in the existing ECU (for example, 30) installed in the vehicle.

The virtual ECU (for example, 420) programmed using the API generated by the API conversion unit 300 is installed in the dummy ECU block (for example, 410_1) of the vehicle terminal 400 (S300). For example, the user may download the virtual ECU (for example, 420) from the server and install the downloaded virtual ECU in the dummy ECU block (for example 410_1).

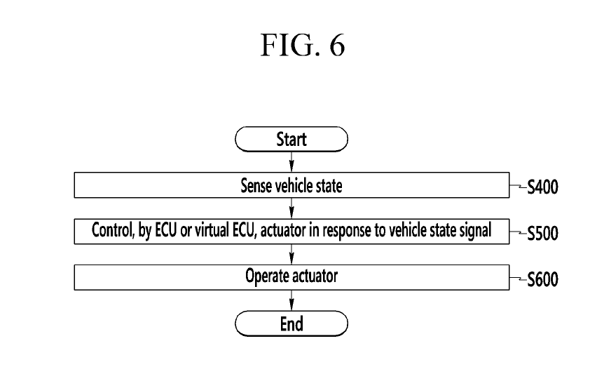

FIG. 6 is a flow chart illustrating a process in which the vehicle control system according to an exemplary embodiment of the present invention controls a vehicle.

The sensing unit 100 senses the vehicle state (S400).

The existing ECU (for example, 30) or the virtual ECU (for example, 420) controls the actuator 500 in response to the vehicle state signal generated by the sensing unit 100 (S500). The actuator 500 drives a specific vehicle apparatus depending on the control of the existing ECU (for example, 30) or the virtual ECU (for example, 420) (S600). For example, as illustrated in FIG. 4, when the existing ECU (for example, 600) receives the vehicle state signal corresponding to the user operation from the side mirror operation key pad 110, the existing ECU (for example, 600) controls the side mirror actuator 510 to change the position of the side mirror. Further, when the virtual ECU (for example, 420) receives the vehicle state signal corresponding to the parking mode from the gear state sensor 130, the virtual ECU (for example, 420) controls the side mirror actuator 510 to adjust the side mirror to meet the parking mode.

In the related art, the signals of the sensors (for example, 110 and 120) connected to the ECU (for example, 600) installed in the vehicle are generally used in the corresponding ECU (for example, 600). However, the vehicle control system according to the exemplary embodiment of the present invention receives the signals of various sensors (for example, 110 to 140) through the vehicle data gateway (for example, 310) which connects several network nodes to utilize data on the vehicle networks. Further, the vehicle control system according to an exemplary embodiment of the present invention converts the specific sensor signal among the sensor signals received by the vehicle data gateway (for example, 310) into the API. Further, the virtual ECU programmed using the API is installed in the dummy ECU blocks 410_1 to 410_N of the vehicle terminal 400. Consequently, it is possible to develop a new hybrid ECU (a controller in which the existing ECU (for example, 600) and the virtual ECU (for example, 420) are combined) using various combinations of the signals of the existing sensors (for example, 110 to 140). Therefore, an advanced ECU function may be added even to a low-specification vehicle.

The actuator may be controlled by the ECU installed in the vehicle and the virtual ECU installed in the terminal. As a result, it is possible to add new ECU functions which may not be added to the existing vehicle control system and improve the performance of the vehicle apparatus (for example, convenient apparatus for a vehicle).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vehicle control system, comprising:
a sensing unit configured to sense a vehicle state and generate a vehicle state signal;
an application program interface (API) conversion unit configured to generate an API corresponding to the vehicle state signal; and
an actuator controlled by a virtual electronic control unit (ECU),
wherein the virtual ECU is a virtual ECU program programmed using the API and installed in a dummy ECU block of a terminal.

2. The vehicle control system of claim 1, wherein:
the API conversion unit includes:
a data gateway configured to connect a plurality of vehicle networks and receive the vehicle state signal;
a filter configured to filter the vehicle state signal received by the data gateway; and
an API module configured to generate the API corresponding to the filtered vehicle state signal.

3. The vehicle control system of claim 2, further comprising:
a converter configured to convert the vehicle state signal into a digital signal and output the converted digital signal to the data gateway when the vehicle state signal is an analog signal; and
a digital input buffer configured to buffer the vehicle state signal and output the buffered vehicle state signal to the data gateway when the vehicle state signal is a digital signal.

4. The vehicle control system of claim 2, wherein:
the terminal includes the plurality of dummy ECU blocks.

5. The vehicle control system of claim 4, wherein:
the terminal is either one of an audio video navigation (AVN) apparatus and a mobile terminal.

6. The vehicle control system of claim 1, wherein:
the virtual ECU is installed in the dummy ECU block to meet a runtime environment of the terminal.

7. The vehicle control system of claim 1, wherein:
the virtual ECU controls the actuator in response to the vehicle state signal.

8. The vehicle control system of claim 7, wherein:
the actuator is controlled by the ECU installed in the vehicle.

9. The vehicle control system of claim 7, wherein:
the vehicle state signal is a gear state signal,
the actuator drives a side mirror, and
the virtual ECU controls the actuator to adjust the side mirror to meet a parking mode when the gear state signal indicates the parking mode.

10. The vehicle control system of claim 7, wherein:
the vehicle state signal is a rain sensing signal,
the actuator drives a side mirror, and
the virtual ECU controls the actuator to operate a hot wire of the side mirror depending on the rain sensing signal.

11. A virtual ECU development method, comprising:
sensing, by a sensor, a vehicle state and generating a vehicle state signal;
generating, by an API module, an API corresponding to the vehicle state signal; and
programming a virtual ECU using the API,
wherein the virtual ECU is installed in a terminal and controls an actuator in response to the vehicle state signal.

12. The virtual ECU development method of claim 11, wherein:
the terminal is a plurality of dummy ECU blocks, and
the virtual ECU is installed in any one of the plurality of dummy ECU blocks.

13. The virtual ECU development method of claim 12, wherein:
the generating of the API includes:
receiving the vehicle state signal through a data gateway which connects a plurality of vehicle networks;
filtering the vehicle state signal received by the data gateway; and
generating the API corresponding to the filtered vehicle state signal.

14. The virtual ECU development method of claim 11, wherein:
the terminal is either one of an AVN apparatus and a mobile terminal.

15. The virtual ECU development method of claim 13, wherein:
the generating of the vehicle state signal includes:
converting the vehicle state signal into a digital signal and outputting the converted digital signal to the data gateway when the vehicle state signal is an analog signal; and
buffering the vehicle state signal and outputting the buffered vehicle state signal to the data gateway when the vehicle state signal is a digital signal.

16. The virtual ECU development method of claim 12, wherein:
the virtual ECU is installed in the dummy ECU block to meet a runtime environment of the terminal.
